(19) United States
(12) Patent Application Publication
(10) Pub. No.: US 2015/0210913 A1
(43) Pub. Date: Jul. 30, 2015

(54) CLAY STABILIZER AND METHOD OF USE

(71) Applicants: D.V. Satyanarayana Gupta, The Woodlands, TX (US); Paul S. Carman, Spring, TX (US)

(72) Inventors: D.V. Satyanarayana Gupta, The Woodlands, TX (US); Paul S. Carman, Spring, TX (US)

(21) Appl. No.: 14/168,418

(22) Filed: Jan. 30, 2014

(51) Int. Cl. C09K 8/18; C09K 8/74; C09K 8/68; E21B 43/16

(52) U.S. Cl. CPC C09K 8/18; E21B 43/16; C09K 8/74; C09K 8/68; C09K 2208/12

(57) ABSTRACT

A clay stabilizer may be used to inhibit the swelling and/or disintegration of clay in a subterranean formation. A subterranean clay-containing formation may be treated with the clay stabilizer by contacting the formation with a well treatment composition containing the clay stabilizer dispersed or dissolved in a carrier fluid. Damage to the formation caused by contact with the well treating composition is reduced or substantially eliminated.

### FIELD OF THE INVENTION

The presently disclosed subject matter relates to a clay stabilizer and use of the clay stabilizer in oil and gas applications.

### BACKGROUND

Production of oil and gas from subterranean formations is dependent upon many factors. For example, migration of fines can reduce the permeability of a formation when the fines become trapped in pore throats of the formation, thus reducing productivity. The source of fines can be swelling clays and/or migrating clays in the formation. Swelling and migration of clays can occur when aqueous well treatment fluids are introduced into the formation.

It is known in the art to use various methods to treat subterranean formations to stabilize the clays against swelling and/or migrating. For example, organic cationic polymers have been utilized as clay stabilizers because they can be effective when dissolved in aqueous treatment fluids in small concentrations, they can resist removal by most subsequent acid and other treatments, and they can result in long life stabilization of formation clays and fines. However, these organic cationic polymers can cause formation damage due to their high molecular weights. The polymeric cationic materials will plate out on the formation face as they cannot leak off into the formation matrix and hence need to be used along with temporary clay control additives like potassium chloride, ammonium chloride or choline chloride. Smaller molecular weight materials such as choline chloride and tetramethyl ammonium chloride have also been utilized as clay stabilizers, but provide only temporary clay protection and can get washed away during subsequent acid or fresh water ingression. Various approaches are also set forth in U.S. Pat. No. 8,084,402 to Berry et al. Improvements in this field of technology are desired.

### SUMMARY

According to the illustrative embodiments disclosed herein, a stabilizer for inhibiting the swelling of clay particulates in a subterranean formation is provided. In certain illustrative embodiments, the stabilizer can be a low molecular weight bisquaternary compound that can function as a permanent clay stabilizer without causing any damage to the subterranean formation. The stabilizer can be available in concentrated solutions and can have applications in drilling, completion and stimulation fluids. For example, the stabilizer can be utilized in well servicing fluids such as drilling fluids, completion fluids, fracturing fluids, cementing fluids, and acidizing fluids.

In certain illustrative embodiments, a method of inhibiting the swelling of clay particulates in a subterranean formation is provided. A well treatment composition is introduced into the subterranean formation which can include a stabilizer entrained in an aqueous fluid. The stabilizer can be a bisquaternary ammonium compound. In certain illustrative embodiments, the stabilizer can have the formula 1,2 bis (trimethylammonium) 2 hydroxypropane dichloride. The aqueous fluid can be delivered with the entrained stabilizer into the subterranean formation. The stabilizer can be in contact with the formation for a time sufficient to inhibit swelling of clay particulates in the formation. The affinity of clay particulates in the formation for the stabilizer can be maintained after treatment of the subterranean formation with the well treatment composition. The aqueous fluid can be selected from the group consisting of a drilling fluid, a drill-in fluid, a stimulation fluid and a gravel pack fluid. The aqueous fluid can be selected from the group consisting of a fracturing fluid and an acidizing fluid. The amount of stabilizer in the well treatment composition can be between from about 0.25 gallons per thousand gallons to about 5 gallons per thousand gallons. The clay can be selected from the group consisting of montmorillonite, saponite, nontronite, hectorite, sauconite; kaolinite, nacrite, dickite, halloysite, hydrobiotite, glauconite, illite, bramallite, chlorite, chamosite, vermiculite, attapulgite and sepiolite.

In certain illustrative embodiments, a method of treating a subterranean formation to substantially prevent swelling of the clay in the formation is provided. A well treatment composition can be introduced into the formation. The well treatment composition can include a stabilizer dispersed, dissolved or entrained in an aqueous fluid. The stabilizer can be a bisquaternary ammonium compound. In certain illustrative embodiments, the stabilizer can have the formula 1,2 bis (trimethylammonium) 2 hydroxypropane dichloride. The aqueous fluid can be selected from the group consisting of a fracturing fluid and an acidizing fluid. The aqueous fluid can be selected from the group consisting of a drilling fluid, a drill-in fluid, a stimulation fluid and a gravel pack fluid. The amount of stabilizer in the well treatment composition can be between from about 0.25 gallons per thousand gallons to about 5 gallons per thousand gallons.

In certain illustrative embodiments, a method of reducing or substantially eliminating permeability damage caused by swellable clay in a subterranean formation is provided. An aqueous well treatment fluid comprising a stabilizer entrained within an aqueous fluid can be introduced into the subterranean formation. The stabilizer can be a bisquaternary ammonium compound. In certain illustrative embodiments, the stabilizer can have the formula 1,2 bis (trimethylammonium) 2 hydroxypropane dichloride. The swelling and migration of the swellable clay in the formation upon exposure of the swellable clay to water can be prevented, whereby the affinity of the swellable clay with the stabilizer prevents the swelling of the swellable clay. The aqueous fluid can be selected from the group consisting of a fracturing fluid, an acidizing fluid, a drilling fluid, a drill-in fluid, a stimulation fluid and a gravel pack fluid.

### BRIEF DESCRIPTION OF THE DRAWINGS

FIG. 1 is a line graph comparing fluid:fluid compatibility test results for the stabilizer and ClayMaster™ 5C in a Vistar 2400 fracturing fluid system in an illustrative embodiment.

FIG. 2 is a line graph comparing fluid:fluid compatibility test results for the stabilizer and ClayMaster™ 5C in a Quadra Frac 2500 fracturing fluid system in an illustrative embodiment.

FIG. 3 is a line graph comparing fluid:fluid compatibility test results for the stabilizer and ClayMaster™ 5C in a Medallion 3000 fracturing fluid system in an illustrative embodiment.

FIG. 4 is a line graph comparing fluid:fluid compatibility test results for the stabilizer and ClayMaster™ 5C in a Medallion HT 3000 fracturing fluid system in an illustrative embodiment.

FIG. 5 is a line graph comparing fluid:fluid compatibility test results for the stabilizer and ClayMaster™ 5C in a Viking 3000 fracturing fluid system in an illustrative embodiment.

FIG. 6 is a line graph comparing fluid:fluid compatibility test results for the stabilizer and ClayMaster™ 5C in a Viking D 3500 fracturing fluid system in an illustrative embodiment.

FIG. 7 is a line graph comparing fluid:fluid compatibility test results for the stabilizer and ClayMaster™ 5C in a Lightning 2500 at 200° F. fracturing fluid system in an illustrative embodiment.

FIG. 8 is a line graph comparing fluid:fluid compatibility test results for the stabilizer and ClayMaster™ 5C in a Lightning 2500 at 275° F. fracturing fluid system in an illustrative embodiment.

FIG. 9 is a line graph comparing fluid:fluid compatibility test results for the stabilizer and ClayMaster™ 5C in a Lightning 4000 fracturing fluid system in an illustrative embodiment.

FIG. 10 is a bar graph comparing capillary suction time testing for the stabilizer and other temporary clay stabilizers with ClayMaster™ 5C in an illustrative embodiment.

FIG. 11 is a bar graph showing sand pack column test results indicating any damage to the sand pack due to clays in the sand pack in an illustrative embodiment.

While certain preferred illustrative embodiments will be described herein, it will be understood that this description is not intended to limit the subject matter to those embodiments. On the contrary, it is intended to cover all alternatives, modifications, and equivalents, as may be included within the spirit and scope of the subject matter as defined by the appended claims.

### DETAILED DESCRIPTION

The presently disclosed subject matter relates to a stabilizer that can be used to inhibit swelling and migration of clay subterranean materials upon exposure to water. The subterranean materials shall be referred to herein as “swellable clays.” The term shall include those clays which swell, disperse, disintegrate or otherwise become disrupted, thereby demonstrating an increase in bulk volume, in the presence of foreign aqueous well treatment fluids such as drilling fluids, stimulation fluids, workover fluids, gravel packing fluids, etc. The term shall include those clays which disperse, disintegrate or otherwise become disrupted without actual swelling. For instance, clays which, in the presence of well treatment fluids, expand and may be disrupted by becoming unconsolidated, thereby producing particles which migrate into a borehole, shall be included by the term.

When combined with an aqueous fluid to render a well treatment composition, the stabilizer is capable of reducing or substantially eliminating damage to the formation caused by the swellable clays. The presence of the stabilizer eliminates or reduces the tendency of the formation clay to swell or disintegrated/migrate upon contact with the well treatment composition.

Such inhibition may be temporary or substantially permanent depending on the quantity of the well treatment composition used to treat the formation. Thus, another advantage of using the disclosed stabilizer is evidenced in its ability to provide permanent clay stabilization. Temporary clay stabilizers are materials that protect the formation only during treatment of the formation with the well treatment fluid. Permanent clay stabilization has been evidenced by use of the disclosed stabilizer. Upon being re-exposed to fresh water, the clay particulates do not swell (or minimally swell), compared to clay particulates that had not been treated with such stabilizer or with a clay stabilizer of the prior art.

In an illustrative embodiment, the stabilizer may be a bisquaternary ammonium compound (a “bisquat”) corresponding to the following general formula:

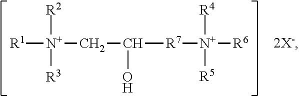

wherein R¹, R², R³, R⁴, R⁵, R⁶ and a R⁷ each can be selected from the group consisting of alkyl, alkylamidoalkyl, arylalkyl, aryl, hydroxyalkyl and carboxyalkyl each having 1-28 carbon atoms and X can be a negative radical anion or radicals, said bisquaternary ammonium compound being further described in U.S. Pat. No. 4,812,263, the contents of which are hereby incorporated herein in their entirety.

In a preferred embodiment, the bisquaternary ammonium compound is 1, 2 bis (trimethylammonium) 2 hydroxypropane dichloride, which is commercially available from SACHEM, Inc. and has the following structural formula, chemical formula and molecular weight:

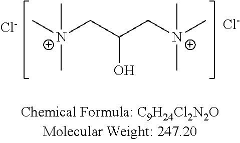

Without wishing to be bound by theory, it is believed that the stabilizer comprising a bisquaternary ammonium compound as described herein advantageously provides two anchor points to the hydroxyl groups on the clays whereby even when fresh water comes into contact with the clays, statistically at least one of the anchors still binds and prevents the clays from hydrating. Further, because of its low molecular weight, the stabilizer can even leak off into the formation matrix thus negating the need to use the stabilizer along with temporary clay control agents which tend to be higher molecular weight polymeric materials (greater than 500) which plate out on the formation face resulting in formation damage, and also negating the need to use the stabilizer in conjunction with low molecular weight temporary clay control agents to prevent clay related issues due to leak off the fluids into the formation matrix.

The aqueous fluid is one which is capable of delivering the stabilizer into the subterranean formation. For instance, the aqueous fluid may be drilling fluid, drill-in fluid, completion fluid, stimulation fluid, fracturing fluid, acidizing fluid, remedial fluid, scale inhibition fluid, gravel pack fluid or the like. Such fluids may contain a gelling agent to increase the viscosity of the fluid. The stabilizer can also be utilized in cementing fluids such as a cement slurry or a cement spacer, in certain illustrative embodiments. In a preferred embodiment, the stabilizer is entrained within the aqueous fluid. In other embodiments, the stabilizer can be made available as a solid material without being dissolved or entrained in the aqueous fluid.

The stabilizer may be admixed with the aqueous fluid in an amount effective to substantially stabilize the shale and/or clay containing formation against permeability reduction upon contact of the formation with the well treatment fluid. The amount of stabilizer in the well treatment composition is typically between from about 0.25 gallons per thousand gallons to about 5 gallons per thousand gallons. Preferably, the amount of stabilizer in the well treatment composition is at least 0.5 gallons per thousand gallons. The stabilizer can be utilized in a 50% aqueous solution, in certain illustrative embodiments.

The stabilizer is effective in treating a subterranean formation when transported in the well treatment composition with the aqueous fluid. The well treatment composition may have an acidic, alkaline or neutral pH, such as those in the range of from about 1 to 11, and may be utilized with aqueous fluids having an acidic, alkaline or neutral pH.

Clays which may effectively be treated with the stabilizer may be of varying shapes, such as minute, plate-like, tube-like and/or fiber-like particles having an extremely large surface area. Suitable clays are clay minerals of the montmorillonite (smectite) group such as montmorillonite, saponite, nontronite, hectorite, and sauconite; the kaolin group such as kaolinite, nacrite, dickite, and halloysite; the hydrousmica group such as hydrobiotite, glauconite, illite and bramallite; the chlorite group such as chlorite and chamosite; clay minerals not belonging to the above groups such as vermiculite, attapulgite, and sepiolite, and mixed-layer varieties of the such minerals and groups. Other mineral components may further be associated with the clay.

In a preferred embodiment, the stabilizer is used to enhance the recovery of hydrocarbon fluids produced from a hydrocarbon-producing subterranean formation. As such, the well treatment composition may be a stimulation fluid wherein the aqueous fluid may be a conventional stimulation treatment fluid, such as those containing a solvatable polysaccharide gelling agent like galactomannan gum, glucomannan gum, cellulose derivative, etc. Such stimulation fluids may therefore be fracture stimulation fluid and/or acid stimulation fluid and may further include a crosslinking agent.

Other well treating applications may be near wellbore in nature (affecting near wellbore regions) and may be directed toward improving wellbore productivity and/or controlling the production of fracture proppant or formation sand. Particular examples include gravel packing and “frac-packs.” Moreover, such particles may be employed alone as a fracture proppant/sand control particulate, or in mixtures in amounts and with types of fracture proppant/sand control materials, such as conventional fracture or sand control particulate.

The aqueous fluid may further contain conventional additives in combination with the stabilizer, including bactericides, gel breakers, iron control agents, foaming agents such as surfactants, gases or liquefied gases, stabilizers, etc.

In order to facilitate a better understanding of the presently disclosed subject matter, the following examples of certain aspects of certain embodiments are given. In no way should the following examples be read to limit, or define, the scope of the presently disclosed subject matter.

### EXAMPLES

### Example 1

The product 1, 2 bis (trimethylammonium) 2 hydroxypropane dichloride, 50% aqueous solution (“TMAHPDC”) was evaluated for use as an alternative clay stabilizer. The product sample was obtained from SACHEM, Inc. The objective of the evaluation was to determine the effectiveness of TMAHPDC compared to currently available permanent clay stabilizer products including ClayMaster™ 5C, which is commercially available from Baker Hughes, Inc.

Fracturing fluid experiments were performed. The analyses included fluid:fluid compatibility with fracturing fluid systems and capillary suction time (“CST”) testing. The fluid:fluid compatibility testing compared the TMAHPDC to the guar and crosslinkers of a fracturing fluid system. The CST results compared the following temporary clay stabilizer products: potassium chloride (KCl), Clay Treat™-3C and ClayCare™, and the permanent clay stabilizer product, ClayMaster™ 5C. The volumes of each fluid additive are reported in gallons per thousand gallons (gpt).

The fluids were prepared by first hydrating 1 liter of linear gel fluid for 30 minutes using a standard Servodyne mixer with a high-efficiency paddle at 1500 rpm. All fluids were made with Tomball tap water. In the Chandler 5550 testing, the fluid was initially sheared at 100s⁻¹ followed by a shear rate sweep at 100, 75, 50, and 25s⁻¹ to calculate the power law indices n′ and K′. The shear rate sweep was repeated at 30 minutes when the fluid had reached the testing temperature (±5° F.). It was repeated every 30 minutes until testing was completed. An R1B5 rotor-bob configuration was used.

This version of the procedure uses a control sample comprised of previously disaggregated fine silica and previously disaggregated fine bentonite.

1. Mix a control sample of 92% previously disaggregated silica and 8% Wyoming bentonite.

2. A 10:1 slurry mixture is formed by adding 0.3 grams of the control sample and 3cc of the test liquid to a 10cc sample vial. For each slurry that is tested, a minimum of 3 vials are prepared. The slurry is shaken to mix and allowed to set 30 minutes for equilibration.

3. The capillary suction time unit is prepared by placing the CST paper on the lower plate and lowering the upper plate into position. The stainless steel funnel is placed into the hole in the center of the upper plate. The timer is reset to zero.

4. The slurry is re-shaken and quickly poured into the funnel. As the liquid migrates away from the sample, it triggers the timer by electric contact with the inner ring. As the liquid continues to migrate outward, the timer is automatically stopped by electric contact with the outer ring. The time is recorded for each sample.

5. Steps 3 and 4 are repeated for each sample container.

6. Steps 3 and 4 are conducted with the test liquid without solids. This value serves as a baseline value for the liquid's effect without solids present on the CST paper.

CST values are normalized to discount the liquid only effects. The charted data represents an average of these normalized values for each sample. The CST testing defines the time of movement of a water front between two electrodes, which is related to the ability of the fluid to flocculate or disperse clays in a sample. When comparing multiple samples in the same fluid, the longer the time of water front movement, the greater the water sensitivity of the sample (the greater the dispersion). When comparing the same sample in different fluids, the longer CST times indicate poorer clay control by the fluid. The CST analysis homogenizes rock samples, therefore exposing all clays or other reactive minerals with the testing solution. This is not a completely valid simulation of the downhole reservoir, since any clay within shale laminations or shale clasts will be exposed to treatment fluids. Additionally, CST analysis is influenced by fluid pH and formation grain size, which can cause misinterpretation of data. CST analysis therefore tends to overestimate the sensitivity of formations to treatment fluids, but can be compared to get a better feel for sensitivity to treatment solutions given the limitations of the analytical procedure.

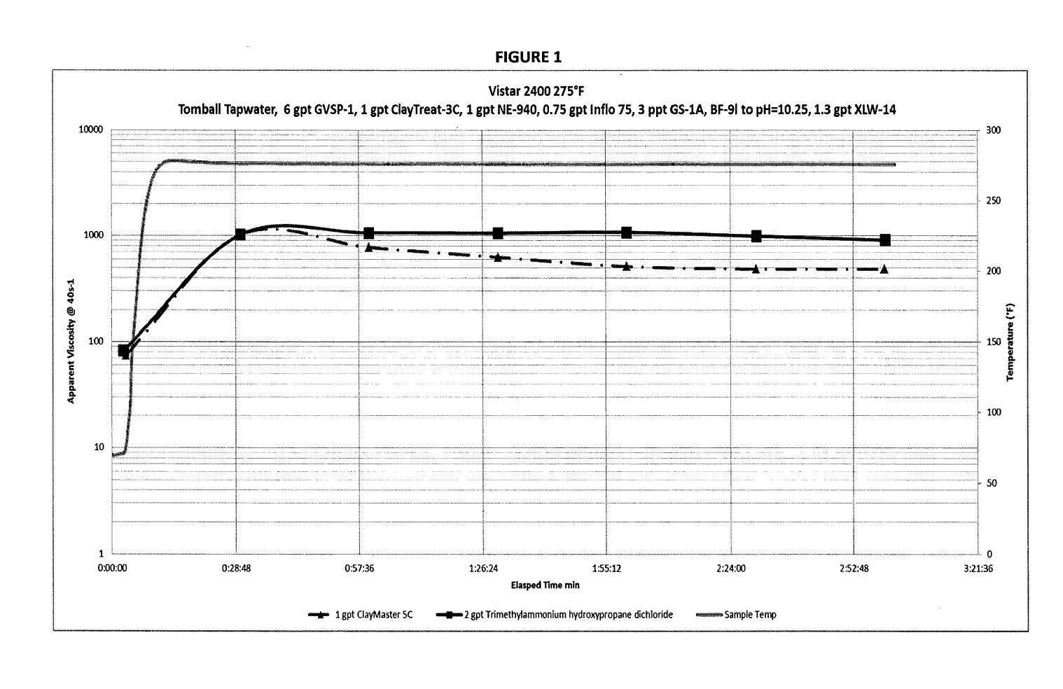

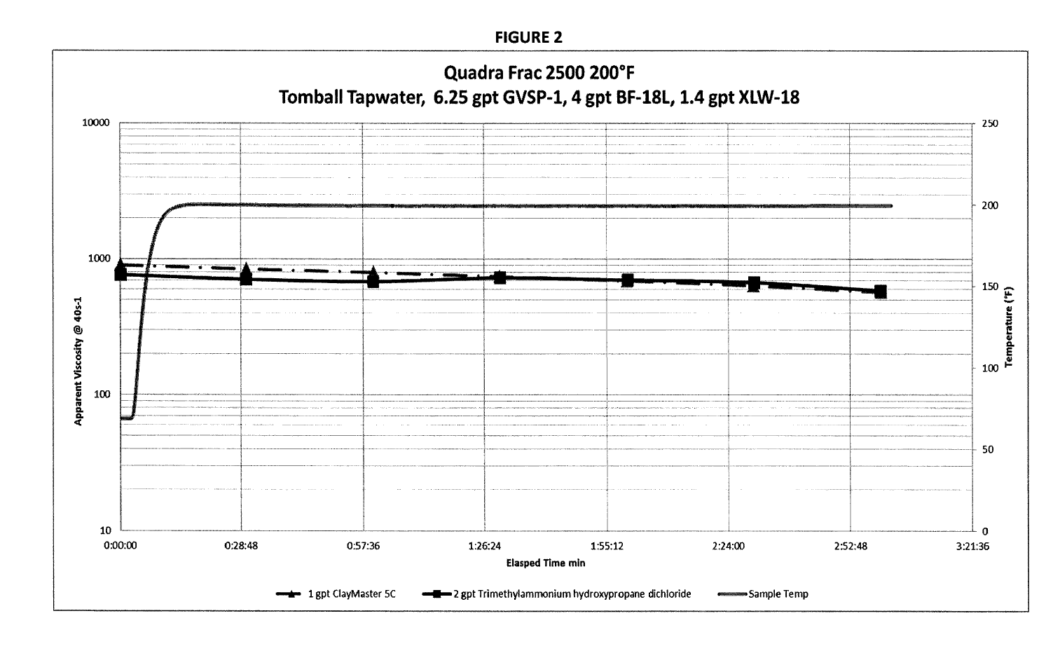

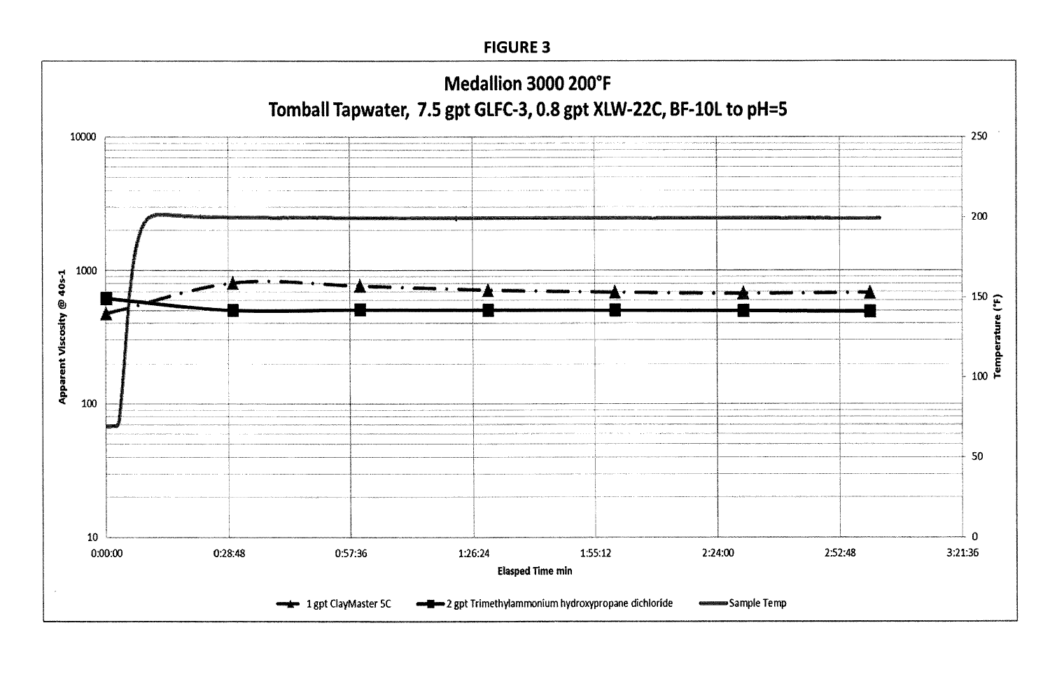

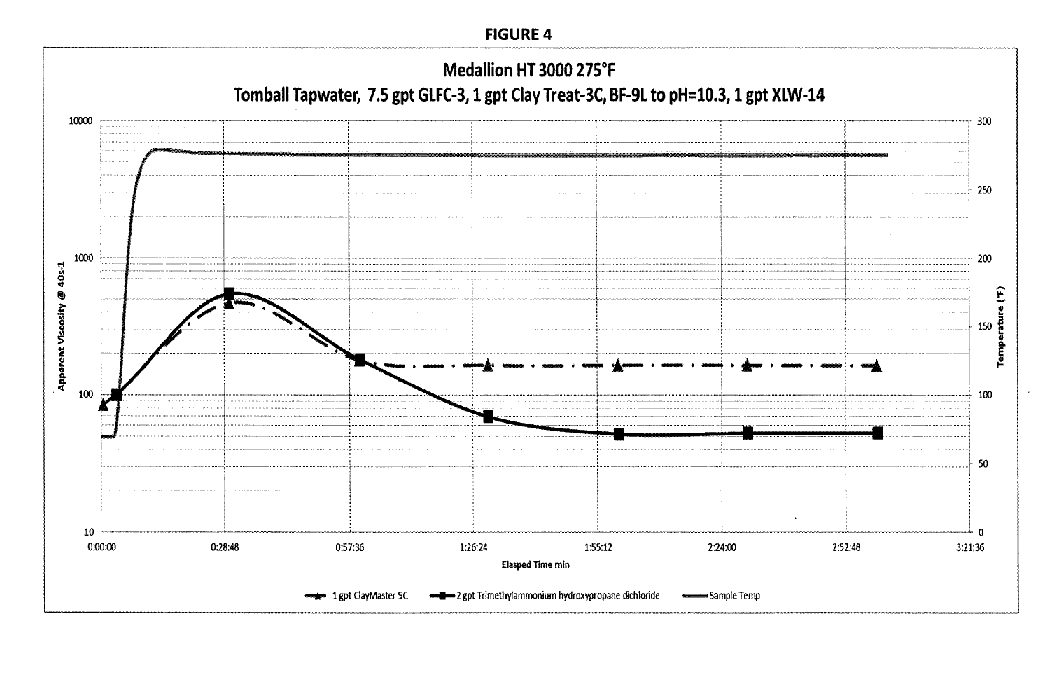

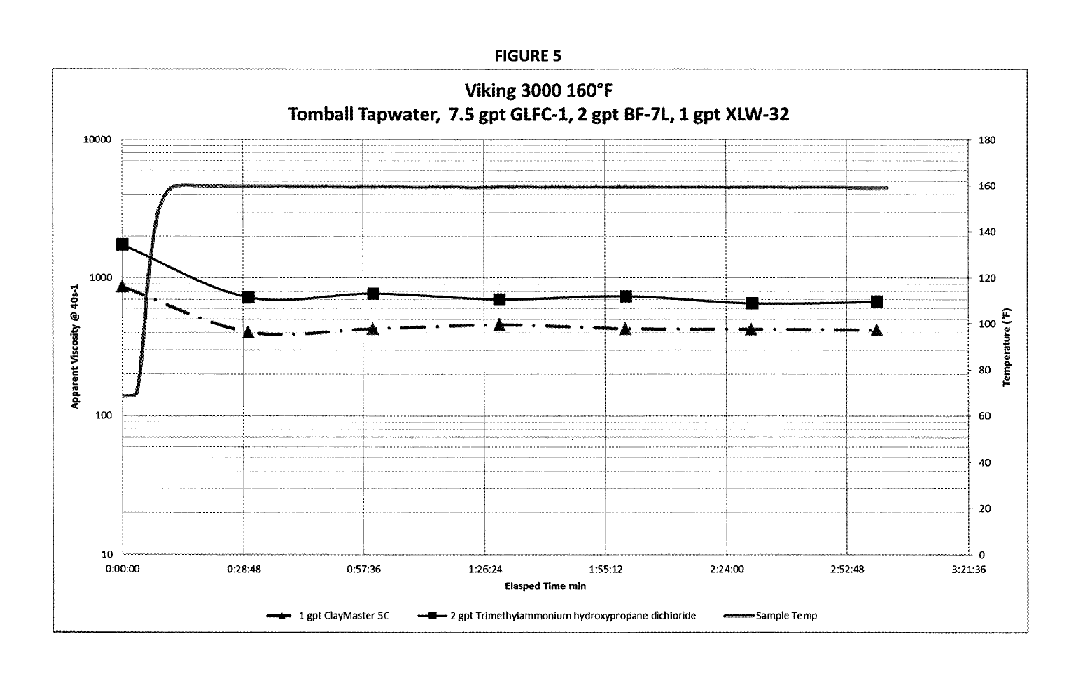

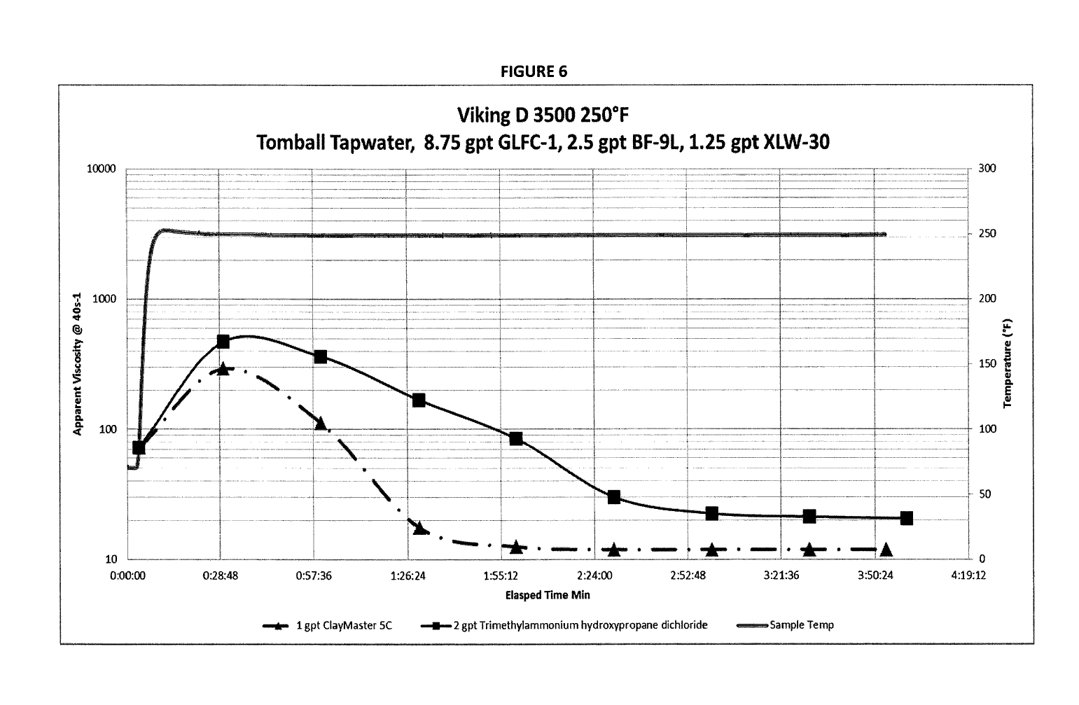

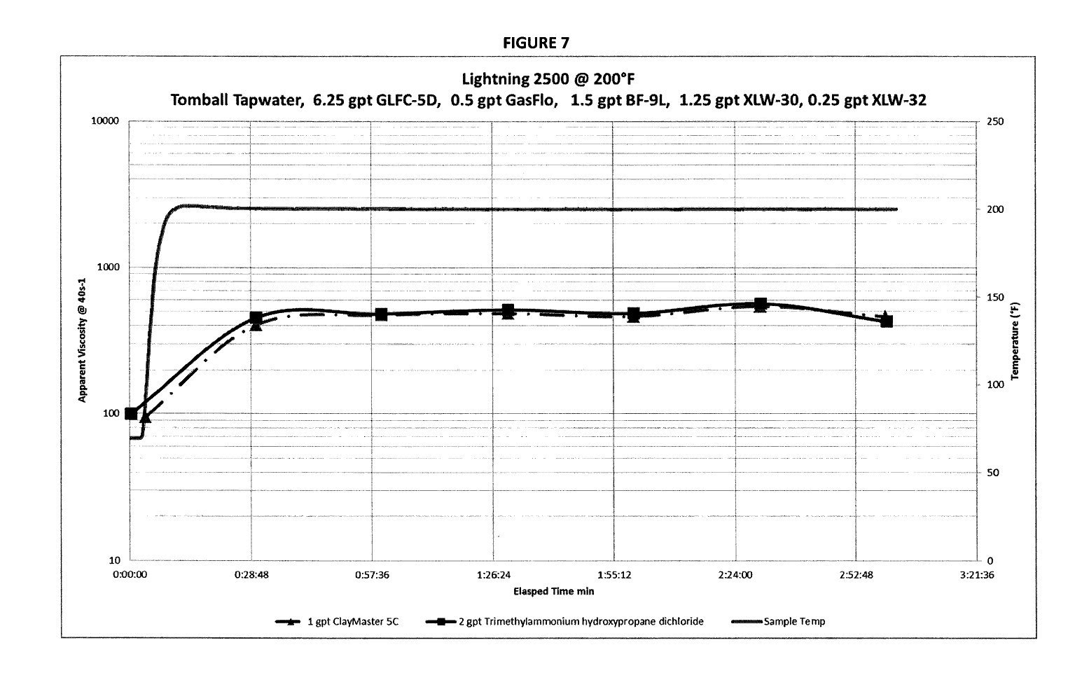

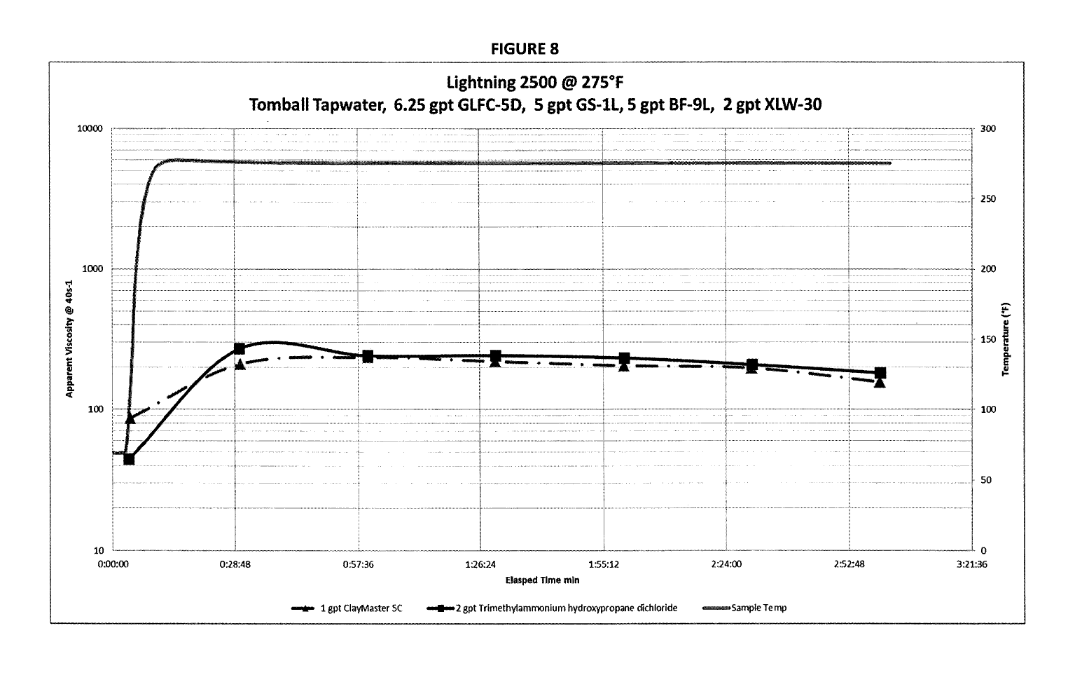

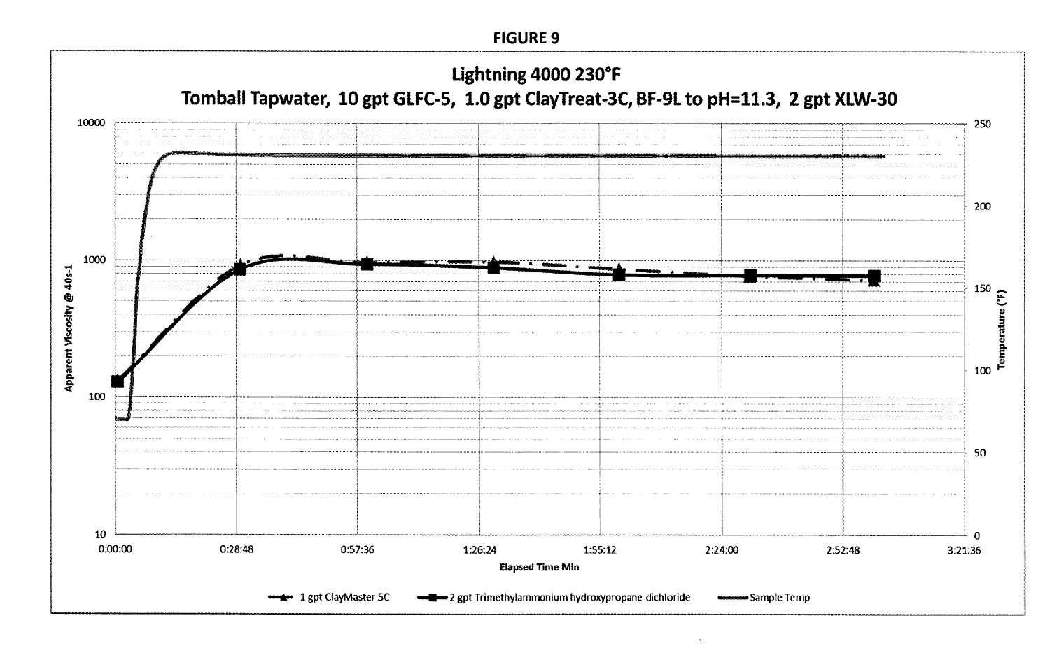

In the fluid:fluid compatibility testing, Vistar™, Viking™, Quadra Frac™, Medallion™ and Lightning™ fracturing fluid systems were used. Formulations and test temperatures are summarized in Table 1 below. Two tests were run for each fluid formulation to compare the clay stabilizer fluids. The baseline test included 1 gpt ClayMaster™ 5C, and the comparison fluid included 2 gpt TMAHPDC. Test results are presented graphically in FIGS. 1-9 herein.

TABLE 1
FRACTURING FLUID SYSTEMS

| | Temp | |
|---|---|---|
| Fluid System | ° F. | |
| | | Transition Metal Crosslinked Formulation |
| | | in Tomball Tap Water |
| Vistar ™ 2400 | 275 | 6 gpt GVSP-1, Clay Stabilizer Fluid*, 1 gpt ClayTreat ™-3C,1 gpt |
| | | NE-940, 0.75 gpt InFlo ™ 75, 3 ppt GS-1A, BF-9L to pH = 10.25, |
| | | 1.3 gpt XLW-14 |
| Quadra Frac ™ | 200 | 6.25 gpt GVSP-1, Clay Stabilizer Fluid*, 4 gpt BF-18L, 1.4 gpt |
| 2500 | | XLW-18 |
| Medallion ™ | 200 | 7.5 gpt GLFC-3, Clay Stabilizer Fluid*, BF-10L to pH = 5, 0.8 gpt |
| 3000 | | XLW-22C |
| Medallion ™ HT | 275 | 7.5 gpt GLFC-3, Clay Stabilizer Fluid*, 1 gpt ClayTreat ™-3C, BF- |
| 3000 | | 9L to pH = 10.3, 1 gpt XLW-14 |
| | | Borate Crosslinked Baseline Formulation |
| | | in Tomball Tap Water** |
| Viking ™ 3000 | 160 | 7.5 gpt GLFC-1, Clay Stabilizer Fluid* , 2 gpt BF-7L, 1 gpt XLW-32 |
| Viking ™ D 3500 | 250 | 8.75 gpt GLFC-1, Clay Stabilizer Fluid*, 2.5 gpt BF-9L, 1.25 gpt |
| | | XLW-30 |
| Lightning ™ | 200 | 6.25 gpt GLFC-5D, Clay Stabilizer Fluid*, 0.5 gpt GasFlo ™, 1.5 gpt |
| 2500 | | BF-9L, 1.25 gpt XLW-30, 0.25 gpt XLW-32 |
| Lightning ™ | 275 | 6.25 gpt GLFC-5D, Clay Stabilizer Fluid*, 5 gpt GS-1L, 5 gpt BF- |
| 2500 | | 9L, 2 gpt XLW-30 |
| Lightning ™ | 230 | 10 gpt GLFC-5, Clay Stabilizer Fluid*, 1 gpt ClayTreat ™-3C, BF- |
| 4000 | | 9L to pH = 11.3,2 gpt XLW-30 |

For the Clay Stabilizer Fluid indicated with a (*), the baseline fluid is 1 gpt ClayMaster™ 5C and the comparison fluid is 2 gpt 1, 2 bis (trimethylammonium) 2 hydroxypropane dichloride, 50% aqueous solution. There is 2% KCl in the Tomball tap water except in formulations with ClayTreat™-3C as noted in Table 1.

The CST testing was performed on a control sample containing 92% silica and 8% bentonite. The testing measured the reaction to the following individual and various combinations of fluids based in fresh water: freshwater, 2% KCl, Clay Treat™-3C, ClayCare™, TMAHPDC, and ClayMaster™ 5C. The results are presented as capillary suction time ratios. All of the liquids were tested without solids, to create a baseline for comparison to sample+liquid travel times. CST ratios are defined as the sample+liquid travel time divided by the corresponding liquid-only travel time.

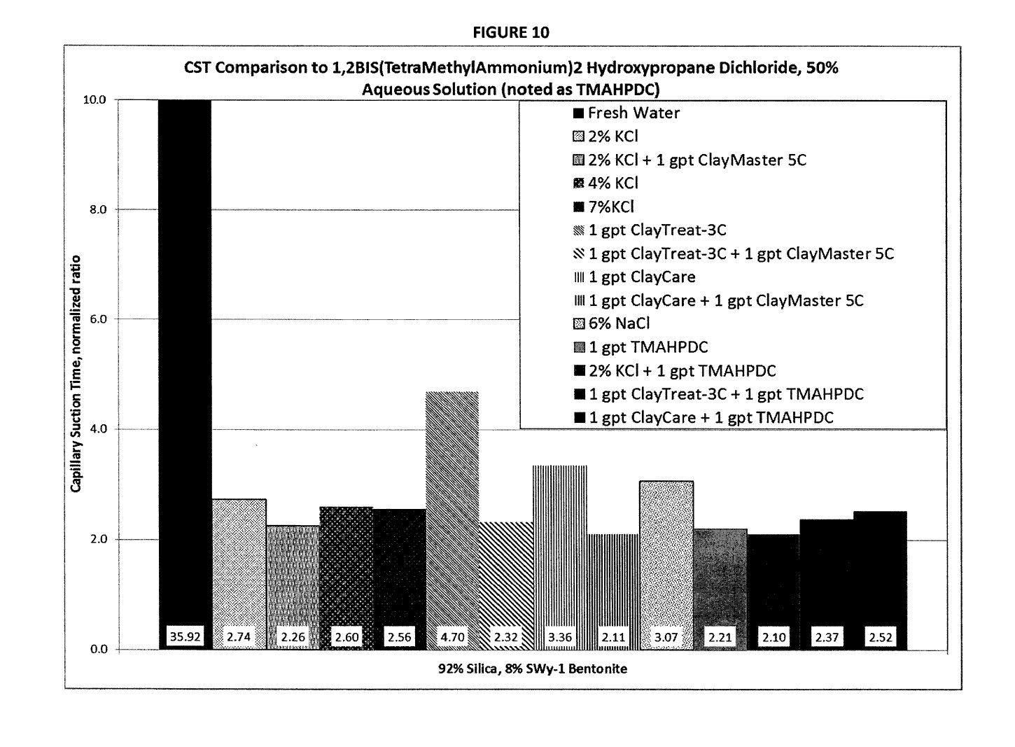

The CST testing evaluated loadings of TMAHPDC at 1.0 gpt with each of the temporary clay stabilizers: 2% KCl, 1 gpt ClayTreat™-3C and 1 gpt ClayCare™. The results were compared to response times of fluid containing 1 gpt ClayMaster™ 5C with each of the temporary clay stabilizers. Results comparing TMAHPDC and ClayMaster™ 5C showed very similar responses. Graphical presentation of this data can be found in FIG. 10 herein.

The test results indicate that TMAHPDC can be effective and comparable to ClayMaster™ 5C. The fluid:fluid compatibility compared TMAHPDC with fracturing fluid systems to determine compatibility with guar and crosslinkers. The product loading for these compatibility tests was 2 gpt. TMAHPDC was compatible with the gelling agents and crosslinkers for all fluid systems. These results show that TMAHPDC qualifies technically for use as an alternative product for clay stabilization in all fluids.

The test results also show that TMAHPDC is as effective as ClayMaster™ 5C in CST testing at the standard loading of 1 gpt. TMAHPDC at 1 gpt performed similarly when paired with 2% KCl, Clay Treat™-3C and ClayCare™ at 1 gpt concentration. These results indicate that TMAHPDC qualifies technically for use as an alternative product for clay stabilization.

### Example 2

The product, 1, 2 bis (trimethylammonium) 2 hydroxypropane dichloride, 50% aqueous solution (“TMAHPDC”) was evaluated as a possible replacement for ClayMaster™ 5C. The product was obtained from SACHEM, Inc. A sample of approximately one liter of TMAHPDC was evaluated. The sample was clear in color with low viscosity at 72° F. The TMAHPDC was tested with temporary clay stabilizers, KCl, ClayCare™, and ClayTreat™ 3C, to determine if it was a viable permanent clay stabilizer.

Production enhancement experiments were performed. The experiments were conducted with a sand/clay test mixture (83% sand/17% clay) consisting of 24.9 grams of silica flour and 5.1 grams of bentonite clay in 250 mL of the test fluid with additives. The test fluids were evaluated with the CST time and the Farm Filter Press using a Whatman No. 50 filter paper with 20 psi pressure to evaluate relative clay swelling. The test procedure for the evaluation of the KCl substitutes or clay stabilizer is as follows:

1. Measure 250 mL of base fluid and place into a Waring blender jar.

2. Add all test additives and mix for 2 minutes. Observe fluid for turbidity, foam and solids.

3. Place 30 grams of sand/clay mixture into the 250 mL of test fluids, and mix for 5 minutes using the high speed setting on the blend and a powerstat set at 50%.

4. After mixing, place the slurry into a 400 mL or 500 mL glass beaker, and allow the slurry to hydrate for 25 minutes. After 15 minutes, remix the slurry with a glass stirring rod, and take a 1 mL sample for CST testing. Record the CST data in seconds. Repeat CST tests to obtain consistent CST readings.

5. Prepare the Farm filter cell by taping the bottom port.

6. Following the hydration, transfer all of the slurry into the Farm Filter Press cell, and place 1 sheet of Whatman No. 50 filter paper on top of the cell.

7. Carefully close the test cell.

8. Shake the cell for 30 seconds before placing the cell on the Fann Filter Press. Be sure to remove the tape from the bottom of the test cell before placing the cell on the filter press.

9. Place a 250 mL beaker under the test cell.

10. Set the filter press at atmospheric pressure, and open the test cell to this pressure and start a timer.

11. Measure and record the cumulative volume of fluid obtained after 5 minutes at atmospheric pressure. Record under 0 time.

12. After 5 minutes, apply 20 psi pressure to the test cell, measuring and recording the total cumulative volume of fluid at 1, 3, 5, and 10 minutes. This cumulative volume also includes the fluid obtained at atmospheric pressure. In certain cases, all of the fluid will be obtained prior to the 10-minute time. When this happens, the time and total volume of fluid should be recorded.

13. To evaluate a chemical additive as a permanent clay stabilizer, collect the filter cake from Step #12 and place it in a Waring blender containing 250 mL of fresh water. Repeat Steps #3 through #12 and obtain the CST and Fann Filter Press results for comparison to the baseline systems.

CST testing defines the time of movement of a water front between two electrodes, which is related to the ability of the fluid to flocculate or disperse clays in a sample. When comparing multiple samples in the same fluid, the longer the time of water front movement, the greater the water sensitivity of the sample (the greater the dispersion). When comparing the same sample in different fluids, the longer CST times indicate poorer clay control by the fluid. CST analysis homogenizes rock samples, therefore exposing all clays or other reactive minerals with the testing solution. This is not a completely valid simulation of the downhole reservoir, since any clays within shale laminations or shale clasts will be exposed to treatment fluids. Additionally, CST analysis is influenced by fluid pH and formation grain size, which can cause misinterpretation of data. CST analysis, therefore, tends to overestimate the sensitivity of formations to treatment fluids (therefore a worst-case scenario) but can be used as a comparator to get a better feel for sensitivity to treatment solutions given the limitations of the analytical procedure. The test results are set forth in Tables 2-5 below.

TABLE 2
CAPILLARY SUCTION TEST (CST) RESULTS

| Original | Average Test Time in |
|---|---|
| Test Fluid ID | Seconds |
| 2% KCl | 41.3 |
| 2% KCl + 1 gpt ClayMaster ™ 5C | 25.5 |
| 2% KCl + 2 gpt ClayMaster ™ 5C | 20.7 |
| Fresh Water + 1 gpt ClayTreat ™ 3C | 323.3 |
| Fresh Water + 1 gpt ClayTreat ™ 3C + | 53.7 |
| 1 gpt ClayMaster ™ 5C | |
| Fresh Water + 1 gpt ClayTreat ™ 3C + | 26.1 |
| 2 gpt ClayMaster ™ 5C | |
| Fresh Water + 1 gpt ClayCare ™ | 315 |
| Fresh Water + 1 gpt ClayCare ™ + | 55.1 |
| 1 gpt ClayMaster ™ 5C | |
| Fresh Water + 1 gpt ClayCare ™ + | 28.9 |
| 2 gpt ClayMaster ™ 5C | |
| 2% KCl + 1 gpt TMAHPDC | 31.2 |
| Fresh Water + 1 gpt ClayTreat ™ 3C + | 63.8 |
| 1 gpt TMAHPDC | |
| Fresh Water + 1 gpt ClayCare ™ + | 51.7 |
| 1 gpt TMAHPDC | |
| Fresh Water + 1 gpt ClayCare ™ + | 30.8 |
| 2 gpt TMAHPDC | |

The CST was run three times per sample to get an average time.

TABLE 3
CAPILLARY SUCTION TEST (CST) RESULTS AFTER
EXPOSURE OF THE FILTER CAKE TO SECONDARY FRESH
WATER

| Original | Average Test Time in |
|---|---|
| Test Fluid ID | Seconds |
| 2% KCl | 219.1 |
| 2% KCl + 1 gpt ClayMaster ™ 5C | 44 |
| 2% KCl + 2 gpt ClayMaster ™ 5C | 29 |
| Fresh Water + 1 gpt ClayTreat ™ 3C | 596.3 |
| Fresh Water + 1 gpt ClayTreat ™ 3C + | 103.4 |
| 1 gpt ClayMaster ™ 5C | |
| Fresh Water + 1 gpt ClayTreat ™ 3C + | 39.1 |
| 2 gpt ClayMaster ™ 5C | |
| Fresh Water + 1 gpt ClayCare ™ | 605.5 |
| Fresh Water + 1 gpt ClayCare ™ + | 101.4 |
| 1 gpt ClayMaster ™ 5C | |
| Fresh Water + 1 gpt ClayCare ™ + | 42.8 |
| 2 gpt ClayMaster ™ 5C | |
| 2% KCl + 1 gpt TMAHPDC | 83.3 |
| Fresh Water + 1 gpt ClayTreat ™ 3C + | 92.8 |
| 1 gpt TMAHPDC | |
| Fresh Water + 1 gpt ClayCare ™ + | 93.8 |
| 1 gpt TMAHPDC | |
| Fresh Water + 1 gpt ClayCare ™ + | 41.4 |
| 2 gpt TMAHPDC | |

The CST was run three times per sample to get an average time.

TABLE 4
FANN FILTER PRESS CLAY STABILIZER EVALUATIONS

| | mL of Fluid/Minutes | | | | | Final Volume and |
|---|---|---|---|---|---|---|
| Test Fluid ID | 0 | 1 | 3 | 5 | 10 | Time |
| 2% KCl | 17 | 77 | 180 | X | X | 230 mL @ 4:18 min. |
| 2% KCl + 1 gpt | 22 | 109 | X | X | X | 232 mL @ 2:30 min. |
| ClayMaster ™ 5C | | | | | | |
| 2% KCl + 2 gpt | 26 | 109 | X | X | X | 233 mL @ 2:15 min. |
| ClayMaster ™ 5C | | | | | | |
| Fresh Water + 1 gpt | 0 | 16 | 30 | 40 | 58 | X |
| ClayTreat ™ 3C | | | | | | |
| Fresh Water + 1 gpt | 0 | 64 | 126 | 146 | X | 212 mL @ 7:38 min. |
| ClayTreat ™ 3C + 1 gpt | | | | | | |
| ClayMaster ™ 5C | | | | | | |
| Fresh Water + 1 gpt | 9 | 106 | 212 | X | X | 220 mL @ 3:04 min. |
| ClayTreat ™ 3C + 2 gpt | | | | | | |
| ClayMaster ™ 5C | | | | | | |
| Fresh Water + 1 gpt | 5 | 12 | 34 | 43 | 60 | X |
| ClayCare ™ | | | | | | |
| Fresh Water + 1 gpt | 10 | 42 | 88 | 122 | 202 | 218 mL @ 11:05 min. |
| ClayCare ™ + 1 gpt | | | | | | |
| ClayMaster ™ 5C | | | | | | |
| Fresh Water + 1 gpt | 12 | 72 | 136 | X | X | 222 mL @ 4:20 min. |
| ClayCare ™ + 2 gpt | | | | | | |
| ClayMaster ™ 5C | | | | | | |
| 2% KCl + 1 gpt | 2 | 123 | X | X | X | 230 mL @ 1:58 min. |
| TMAHPDC | | | | | | |
| Fresh Water + 1 gpt | 5 | 64 | 114 | 148 | 214 | 218 mL @ 10:20 min. |
| ClayTreat ™ 3C + 1 gpt | | | | | | |
| TMAHPDC | | | | | | |
| Fresh Water + 1 gpt | 5 | 72 | 130 | 170 | X | 219 mL @ 7:44 min. |
| ClayCare ™ + 1 gpt | | | | | | |
| TMAHPDC | | | | | | |
| Fresh Water + 1 gpt | 2 | 102 | 202 | X | X | 224 mL @ 3:21 min. |
| ClayCare ™ + 2 gpt | | | | | | |
| TMAHPDC | | | | | | |

The Fann Filter Press was left for 5 minutes at atmospheric pressure for the initial reading (0). After 5 minutes, 20 psi air pressure was applied to the Fann Filter Press, and cumulative fluid volumes were recorded at 1, 3, 5, and 10 minutes.

TABLE 4
FANN FILTER PRESS CLAY STABILIZER
EVALUATIONS AFTER EXPOSURE OF
THE FILTER CAKE TO SECONDARY FRESH WATER

| | | | | | | Final |
|---|---|---|---|---|---|---|
| | mL of Fluid/Minutes | | | | | Volume |
| Test Fluid ID | 0 | 1 | 3 | 5 | 10 | and Time |
| 2% KCl | 5 | 22 | 38 | 46 | 62 | X |
| 2% KCl + | 5 | 32 | 64 | 94 | 161 | X |
| 1 gpt ClayMaster ™ 5C | | | | | | |
| 2% KCl + | 5 | 72 | 159 | 228 | X | 249 mL @ |
| 2 gpt ClayMaster ™ 5C | | | | | | 5:45 min. |
| Fresh Water + | 0 | 13 | 22 | 29 | 44 | X |
| 1 gpt ClayTreat ™ 3C | | | | | | |
| Fresh Water + | 0 | 46 | 86 | 115 | 170 | X |
| 1 gpt ClayTreat ™ 3C + | | | | | | |
| 1 gpt ClayMaster ™ 5C | | | | | | |
| Fresh Water + | 3 | 82 | 166 | 232 | X | 250 mL @ |
| 1 gpt ClayTreat ™ 3C + | | | | | | 5:36 min. |
| 2 gpt ClayMaster ™ 5C | | | | | | |
| Fresh Water + | 0 | 12 | 22 | 30 | 46 | X |
| 1 gpt ClayCare ™ | | | | | | |
| Fresh Water + | 8 | 50 | 93 | 122 | 179 | X |
| 1 gpt ClayCare ™ + | | | | | | |
| 1 gpt ClayMaster ™ 5C | | | | | | |
| Fresh Water + | 9 | 89 | 171 | 222 | X | 250 mL @ |
| 1 gpt ClayCare ™ + | | | | | | 6:30 min. |
| 2 gpt ClayMaster ™ 5C | | | | | | |
| 2% KCl + 1 gpt TMAHPDC | 3 | 36 | 68 | 94 | 150 | X |
| Fresh Water + | 8 | 48 | 86 | 113 | 164 | X |
| 1 gpt ClayTreat ™ 3C + | | | | | | |
| 1 gpt TMAHPDC | | | | | | |
| Fresh Water + | 2 | 46 | 88 | 116 | 172 | X |
| 1 gpt ClayCare ™ + | | | | | | |
| 1 gpt TMAHPDC | | | | | | |
| Fresh Water + | 0 | 38 | 121 | 184 | X | 248 mL @ |
| 1 gpt ClayCare ™ + | | | | | | 7:45 min. |
| 2 gpt TMAHPDC | | | | | | |

The Fann Filter Press was left for 5 minutes at atmospheric pressure for the initial reading (0). After 5 minutes, 20 psi air pressure was applied to the Fann Filter Press, and cumulative fluid volumes were recorded at 1, 3, 5, and 10 minutes.

The test results on TMAHPDC showed that in the CST and Fann Filter Press testing, both the 2% KCl and 1 gpt ClayCare™ with 1 gpt TMAHPDC had comparable or slightly higher CST and Fann Filter readings to 2% KCl+1 gpt ClayMaster™ 5C and Fresh water+1 gpt ClayCare™+1 gpt ClayMaster™ 5C. Even though temporary clay stabilizers with ClayMaster™ 5C had a slightly lower CST and Fann Filter times, the temporary clay stabilizers with the TMAHPDC were very comparable. Tests with increased concentrations of TMAHPDC at 2 gpt had improved CST and Fann Filter times in comparison to the 2 gpt of ClayMaster™ 5C.

The secondary exposure of the original sand pack to fresh water tests showed that the TMAHPDC did perform well as a permanent clay stabilizer. The CST times and Fann Filter test results, after secondary exposure to water, were comparable to those containing ClayMaster™ 5C. These tests showed that the TMAHPDC performed as well as the current permanent clay stabilizer, ClayMaster™ 5C, in the 17% clay content sand pack.

### Example 3

Sand pack column testing was performed to determine if any damage to the sand pack occurred due to clays in the sand pack. Samples used were 800 ml of 8% NaCl, 400 ml of clay stabilizer (TMAHPDC) in 8% NaCl, and 400 ml fresh water.

Two accumulators were manifolded together to provide a transition from one fluid to the next. The Lexan column was composed of two end caps sealed with o-rings and a 200 mesh screen to prevent the 100 mesh sand from falling or washing out. The column was sand packed with 100 mesh sand at the base, a blend of 100 mesh sand silica flour and Bentonite and a cap of 100 mesh sand on the top. The mixture was composed of 85% 100 mesh sand, 10% silica flour and 5% Bentonite. The pressure was set at 12 psi.

Testing involved changing the fluid several times to see if the clay product protects and stays with the pack or washes out and swells the clay. Since the density of each fluid is known, a volume can be calculated from the weight. In order to capture the flow rate through the pack, a balance and a computer were used to record the weight of the fluid coming out of the column. The procedure was as follows:

1. Establish baseline with 8% NaCl from Accumulator A.

2. Run selected stabilizer in 8% NaCl from Accumulator B.

3. Flush column again with 8% NaCl from Accumulator A.

4. Run fresh water through column from Accumulator B.

5. Flush again with 8% NaCl from Accumulator A.

Step 1:

The column was dry packed and hooked up to the accumulators and the valve switched to the 8% NaCl in Accumulator A. The balance was tarred with the container to collect the fluid. The communication through the hyper-terminal was opened and a file name saved for each run. The valve on the column was kept open and valve to Accumulator A was slowly opened to allow the fluid to flow. The test was started when the first drop hit the beaker. The 8% NaCl was flowed until 100 ml was captured. The valve on the column was closed and the test was paused.

Step 2:

The valves were switched to Accumulator B. The test was resumed and at the same time the valve on the column was opened to collect the treatment fluid containing the surfactant. The treatment fluid was allowed to flow until 100 ml was obtained. The valves to Accumulator B were then closed. The valve on the column was also closed and the test was paused simultaneously.

Step 3:

The valves were changed back to Accumulator A with 8% NaCl. The test was resumed and at the same time the valves on the column was opened to collect the base fluid. The 8% NaCl was flowed until 100 ml was captured. The valve on the column was closed and the test was paused. The accumulators were taken apart. Accumulator A was filled with 8% NaCl and Accumulator B with fresh water. Both lines were bled to remove air from the lines. Accumulator B was bled first followed by the first one. Each bleed down was approximately 75 ml.

Step 4:

The valves were switched to Accumulator B. The test was resumed and simultaneously the valve on the column was opened to collect 100 ml of fresh water. Again the valves to Accumulator B were closed, the valve on the column was also closed and the test paused simultaneously.

Step 5:

The valves were changed back to Accumulator A with 8% NaCl. The test was resumed and at the same time the valves on the column were opened to collect the base fluid. The 8% NaCl was flowed until 100 ml was captured. The valves to accumulator and the column were closed and the test was stopped.

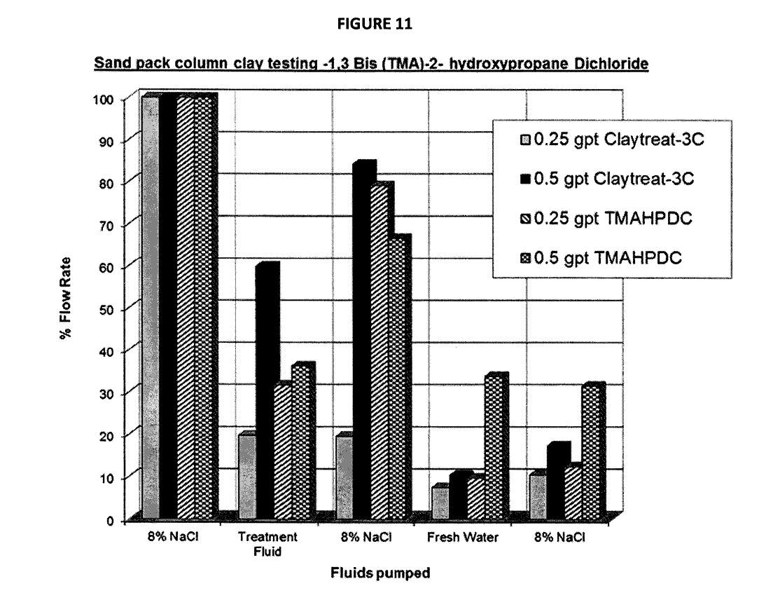

The data was then taken and plotted volume vs. time. Graphical presentation of this data can be found in FIG. 11 herein. This plot shows the changes in the flow rate which can be used to determine the effectiveness of the chosen stabilizer. If the flow rate does not change from the base salt solution, then the stabilizer protects and controls the clays. Varying slopes off of the baseline will show decreasing protection. This data can be normalized and shown as a percent flow rate.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter. Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

What is claimed is:

1. A method of inhibiting the swelling of clay particulates in a subterranean formation comprising:
introducing into the subterranean formation a well treatment composition comprising a stabilizer entrained in an aqueous fluid, wherein the stabilizer comprises a bisquaternary ammonium compound having the formula 1,2 his (trimethylammonium) 2 hydroxypropane dichloride; and
delivering the aqueous fluid with the entrained stabilizer into the subterranean formation wherein the stabilizer is in contact with the formation for a time sufficient to inhibit swelling of clay particulates in the formation and the affinity of clay particulates in the formation for the stabilizer is maintained after treatment of the subterranean formation with the well treatment composition.

2. The method of claim 1, wherein the aqueous fluid is selected from the group consisting of a drilling fluid, a drill-in fluid, a stimulation fluid and a gravel pack fluid.

3. The method of claim 1, wherein the aqueous fluid is selected from the group consisting of a fracturing fluid and an acidizing fluid.

4. The method of claim 1, wherein the amount of stabilizer in the well treatment composition is between from about 0.25 gallons per thousand gallons to about 5 gallons per thousand gallons.

5. The method of claim 1, wherein the clay is selected from the group consisting of montmorillonite, saponite, nontronite, hectorite, sauconite; kaolinite, nacrite, dickite, halloysite, hydrobiotite, glauconite, illite, bramallite, chlorite, chamosite, vermiculite, attapulgite and sepiolite.

6. A method of treating a subterranean formation to substantially prevent swelling of the clay in the formation which comprises introducing into the formation a well treatment composition comprising a stabilizer dispersed, dissolved or entrained in an aqueous fluid, wherein the stabilizer is a bisquaternary ammonium compound having the formula 1,2 bis (trimethylammonium) 2 hydroxypropane dichloride.

7. The method of claim 6, wherein the aqueous fluid is selected from the group consisting of a fracturing fluid and an acidizing fluid.

8. The method of claim 6, wherein the aqueous fluid is selected from the group consisting of a drilling fluid, a drill-in fluid, a stimulation fluid and a gravel pack fluid.

9. The method of claim 6, wherein the amount of stabilizer in the well treatment composition is between from about 0.25 gallons per thousand gallons to about 5 gallons per thousand gallons

10. A method of reducing or substantially eliminating permeability damage caused by swellable clay in a subterranean formation comprising:
introducing into the subterranean formation an aqueous well treatment fluid comprising a stabilizer entrained within an aqueous fluid, wherein the stabilizer is a bisquatemary ammonium compound having the formula 1,2 his (trimethylammonium) 2 hydroxypropane dichloride; and
preventing the swelling and migration of the swellable clay in the formation upon exposure of the swellable clay to water, the affinity of the swellable clay with the stabilizer preventing the swelling of the swellable clay.

11. The method of claim 10, wherein the aqueous fluid is selected from the group consisting of a fracturing fluid, an acidizing fluid, a drilling fluid, a drill-in fluid, a stimulation fluid and a gravel pack fluid.

12. A method of inhibiting the swelling of clay particulates in a subterranean formation comprising:
introducing into the subterranean formation a well treatment composition comprising a stabilizer entrained in an aqueous fluid, wherein the stabilizer comprises a bisquatemary ammonium compound having the formula: 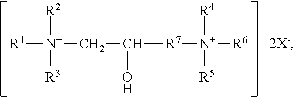
wherein R¹, R², R³, R⁴, R⁵, R⁶ and R⁷ each are selected from the group consisting of alkyl, alkylamidoalkyl, arylalkyl, aryl, hydroxyalkyl and carboxyalkyl each having 1-28 carbon atoms and X is a negative radical anion or radicals; and
delivering the aqueous fluid with the entrained stabilizer into the subterranean formation wherein the stabilizer is in contact with the formation for a time sufficient to inhibit swelling of clay particulates in the formation and the affinity of clay particulates in the formation for the stabilizer is maintained after treatment of the subterranean formation with the well treatment composition.

13. A method of treating a subterranean formation to substantially prevent swelling of the clay in the formation which comprises introducing into the formation a well treatment composition comprising a stabilizer dispersed, dissolved or entrained in an aqueous fluid, wherein the stabilizer is a bisquaternary ammonium compound having the formula: 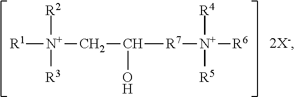
wherein R¹, R², R³, R⁴, R⁵, R⁶ and R⁷ each are selected from the group consisting of alkyl, alkylamidoalkyl, arylalkyl, aryl, hydroxyalkyl and carboxyalkyl each having 1-28 carbon atoms and X is a negative radical anion or radicals.

14. A method of reducing or substantially eliminating permeability damage caused by swellable clay in a subterranean formation comprising:
introducing into the subterranean formation an aqueous well treatment fluid comprising a stabilizer entrained within an aqueous fluid, wherein the stabilizer is a bisquaternary ammonium compound having the formula: 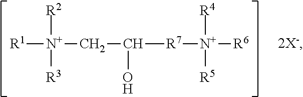
wherein R¹, R², R³, R⁴, R⁵, R⁶ and R⁷ each are selected from the group consisting of alkyl, alkylamidoalkyl, arylalkyl, aryl, hydroxyalkyl and carboxyalkyl each having 1-28 carbon atoms and X is a negative radical anion or radicals; and
preventing the swelling and migration of the swellable clay in the formation upon exposure of the swellable clay to water, the affinity of the swellable clay with the stabilizer preventing the swelling of the swellable clay.
